(19) United States
(12) Patent Application Publication
(10) Pub. No.: US 2005/0227119 A1
(43) Pub. Date: Oct. 13, 2005

(54) Hydraulic composite material having photocatalytic function and method for production thereof

(75) Inventor: Toru Nonami, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Institute of Advanced Indust Sci & Tech

(21) Appl. No.: 10/519,850

(22) PCT Filed: Jul. 22, 2003
(86) PCT No.: PCT/JP03/09278

§ 371 Date: Jan. 13, 2005

(30) Foreign Application Priority Data
Jul. 23, 2002 (JP) 2002-213637

(51) Int. Cl. C09D 1/06; B32B 9/00; C04B 28/34

(52) U.S. Cl. 428/703; 106/772

(57) ABSTRACT

The present invention provides a hydraulic composite material endowed with multiple functions such as a photocatalytic function, and a method for production thereof, and relates to hydraulic a composite material having a substance-adsorbing function, humidity-adjusting function, and/or photocatalytic function, the material being characterized in that calcium silicate cement or a calcium phosphate cement is deposited as a hydraulic material on a suitable substrate in the presence of water so as to be hardened and to thereby cause the cement to solidify, be fixed, and self-adhere to the application surface; and also relates to a method for producing a hydraulic composite material characterized in that a suspension or solution containing the above hydraulic material is mixed with a photocatalyst.

### TECHNICAL FIELD

The present invention relates to a hydraulic composite material having a photocatalytic function or the like and a method for production thereof, and more particularly relates to a hydraulic composite material endowed with a substance-adsorbing function, humidity-adjusting function, photocatalytic function, and/or other composite functions by depositing hydraulic calcium silicate cement or calcium phosphate cement on a suitable substrate in the presence of water to thereby harden the cement and cause the cement to solidify, be fixed and self-adhere to the application surface; to a method of production thereof; and to an application thereof.

### BACKGROUND ART

Materials having a deodorizing function or other substance-adsorbing function, humidity-adjusting materials having a function for absorbing and removing moisture in the air and adjusting humidity, and other materials designed with the aim of environmental cleanup are commonly used as construction material, paint, and other materials. Also, photocatalysts operate to dissolve organic toxins using sunlight or fluorescent light as energy, so application of photocatalysts is already being made in various situations as an environmental cleaning material. The most common and wide-ranging application of these materials is in methods of forming and applying paints. For this reason, various binders and adhesives are mixed, applied, and allowed to dry and harden under normal temperature or under heated conditions.

Examples of methods that have been proposed (Japanese Patent Application Laid-Open No. 11-209691) include organosilane oligomers as binders; and titanium dioxide paints that contain acids, alkali, zinc compounds, and the like. Also proposed (Japanese Patent Application Laid-Open No. 2000-017199) is a paint that hardens at normal temperature and is obtained by dispersing titanium dioxide and silicon dioxide in alcohol and dissolving the product together with ethyl silicate, a silane coupling agent, and methyl glycol. There is also a titanium dioxide paint that can be hardened at normal temperature and has excellent adhesive properties (Japanese Patent Application Laid-Open No. 2000-063704).

However, forming paint from a photocatalytic material has several problematical points. One of these problems is that organic binders and adhesives cannot be used because the photocatalyst itself acts to dissolve organic matter. An inorganic binder is normally used for this reason. The paint cannot be applied to organic materials for the same reason, so an inorganic paint is commonly applied in advance as a base. This, however, requires extra time and costs. Furthermore, there is a drawback in that the photocatalyst is substantially incapable of adsorbing substances, so only substances that come into contact with the surface can be adsorbed, and adequate effect cannot be obtained with its application.

These drawbacks are solved by coating the photocatalyst with an inactive ceramic as a photocatalyst, as described below. In other words, composite materials obtained by applying apatite to titanium dioxide (Japanese Patent Application Laid-Open No. 10-244166) have been proposed. This environmental cleaning material can be formed by immersing titanium oxide particles or a substrate with a titanium oxide film in an artificial body fluid in which the composition, pH, and the like have been adjusted so as to facilitate the generation of a porous calcium phosphate film. There are high expectations for the maintenance-free, semi-permanent use of this composite material because apatite adsorbs substances, and titanium dioxide dissolves the adsorbed substances.

There is, however, another drawback that is not yet solved. This problem lies in the fact that mixing a binder with photocatalytic particles causes the photocatalytic particles to be partially coated by the binder, and only a portion of the particles are exposed on the surface. Naturally, only the portion of the material exposed on the surface functions as intended. Ordinarily, 40% to 70% of the particle surface is masked. It is for this reason that work is being carried out in this technological field to develop environmental cleaning materials that have an excellent substance-adsorbing function and allow a coating to be formed even when the binder is used in a minimal amount or not used at all.

Thus, materials having an adsorbing function or other environmental cleaning function can easily be used in environmental cleaning and other functions in various locations by the application of the pulverulent form of these materials. Also, a plurality of functional materials may be mixed in order to obtain a plurality of functions in a composite manner. However, a binder or other adhesive is required to fashion a material into paint, and simply mixing ingredients together to obtain a composite pulverulent material may prevent the composited functions from being adequately exhibited, so a higher level of compositing is needed.

### DISCLOSURE OF THE INVENTION

Given such conditions, the present inventor, as a result of earnest investigation conducted in view of prior art and aimed at addressing the aforementioned problems with current humidity-adjusting materials, deodorizing materials, photocatalysts, and other materials, perfected the present invention upon conducting further research after discovering that fine particles that are composed of calcium-based material and have excellent adsorbing function for odors and the like also have hydraulic properties.

In other words, an object of the present invention is to provide a hydraulic composite material having a substance-adsorbing function, humidity-adjusting function, and/or photocatalytic function, characterized in being prepared by applying a coating to a suitable substrate in the presence of water to thereby harden the coating and to cause the coating to solidify, be fixed, and self-adhere to the application surface.

Another object of the present invention is to provide novel a hydraulic composite material that is joined by a hydraulic material interlaced after hardening, and that has a self-adhesive function whereby the hydraulic material adheres and hardens on the base of the application surface even when a binder is not present.

Yet another object of the present invention is to provide a novel composite material characterized in that a material that has an adsorbing function and an environmental cleaning function is provided with self-hardening and self-adhesive properties, and not only is the adsorbing material hardened and fixed, but the two components of the composite material are bonded together and efficiently composited solely by the application of the adsorbing material to a substrate without the use of a binder.

The present invention for solving the above-described problems comprises the following technical materials and methods.

(1) A hydraulic composite material having a substance-adsorbing function, humidity-adjusting function, and/or photocatalytic function, characterized in that calcium silicate cement or calcium phosphate cement is deposited as a hydraulic material on a suitable substrate in the presence of water to so as be hardened and to thereby cause the cement to solidify, be fixed, and self-adhere to the application surface.

(2) The composite material according to claim (1), characterized in that the substrate is a humidity-adjusting material or a photocatalyst.

(3) The composite material according to claim (1), characterized in that the hydraulic material is applied to the surface of the photocatalytic particles and that the photocatalytic particles are bonded by a hydration reaction via the hydraulic material.

(4) The composite material according to claim (1), characterized in that calcium silicate cement as the hydraulic material has as its main component calcium silicate, calcium aluminate silicate, or calcium magnesium silicate.

(5) The composite material according to claim (4), characterized in that the calcium silicate is alite or belite, the calcium aluminate silicate is anorthite, and the calcium magnesium silicate is diopside.

(6) The composite material according to claim (1), characterized in that calcium phosphate cement as the hydraulic material is octacalcium phosphate.

(7) A method of producing hydraulic composite material, characterized in that a suspension or solution containing the above hydraulic material is mixed with a photocatalyst.

(8) A method of producing hydraulic composite material, characterized by immersing a photocatalyst in a solution containing phosphorus and calcium, and depositing the hydraulic calcium phosphate on the surface thereof.

(9) The method of producing hydraulic composite material according to claim (8), characterized in that octacalcium phosphate is deposited on the surface by hydrolyzing octacalcium phosphate.

(10) The method of producing hydraulic composite material according to claim (8), characterized in that the calcium phosphate has photocatalytic properties.

(11) The method of producing hydraulic composite material according to claim (10), characterized in that the photocatalytic activity of the calcium phosphate is brought about by light with a wavelength of 250 nm or less, does not occur with sunlight, fluorescent light, or another normal light source, and is initiated solely when irradiated with low-wavelength UV.

(12) A structural member characterized in that the hydraulic composite material according to any of claims 1 to 5 is formed on the surface of a structural member, and a substance-adsorbing function, humidity-adjusting function, and/or photocatalytic function is imparted thereto.

The present invention is described in further detail below.

The present invention relates to a hydraulic composite material having a substance-adsorbing function, humidity-adjusting function, and/or photocatalytic function, characterized in that calcium silicate cement or calcium phosphate cement is deposited as a hydraulic material on a suitable substrate in the presence of water so as to be hardened and to thereby cause the cement to solidify, be fixed, and self-adhere to the application surface. In the present invention, a humidity-adjusting material or a photocatalyst, for example, may be used as the substrate, but no limitation is imposed thereby. The photocatalyst may be titanium dioxide or any photocatalyst having photocatalytic activity. In the case of titanium dioxide in particular, there should be photocatalytic activity with the anatase type and the rutile type. The particle diameter is between 1 nm and several millimeters. The shape may be a powder or a thin film. It may, for example, be titanium dioxide that is rendered active in visible light through generation of an oxygen deficiency by a plasma treatment, baking in a nitrogen atmosphere, or another method; or titanium oxide that is doped with metal ions derived from a metal compound. Also possible is a composite material composed of titanium dioxide coated with apatite or an inactive ceramic.

In the present invention, calcium silicate, calcium aluminate silicate, and calcium magnesium silicate are used as the calcium silicate cement. These substances are hydraulic materials and have an excellent adsorbing function for odors and the like. Calcium silicate, calcium aluminate silicate, calcium magnesium silicate, and other calcium silicate materials may be prepared as described below.

The following components are mixed in predetermined proportions: calcium carbonate, calcium oxide, calcium chloride, or the like as the calcium component; magnesium oxide or magnesium carbonate as the magnesium component; aluminum oxide as the aluminum component; and silica as the silicon component. Favorable examples of these include sintered ceramic powders composed of diopside (CaOMgO₂SiO₂), akermanite (2CaO.MgO.2SiO₂), alite (3CaO.SiO₂), belite (2CaO.SiO₂), anorthite (CaO.Al₂O₃.2SiO₂), or another composition, but no limitation is imposed thereby, and any calcium silicate material may be used. Crystalline material or vitreous material may be used, but vitreous material is preferred for its short hardening time and high adhesive strength. Even more preferred is akermanite for its high hardening velocity.

CaCO₃, MgO, and SiO₂ are weighed and mixed so as to achieve a desired composition of crystalline material or vitreous material. The resulting mixture is heated at a predetermined temperature, and a crystalline material or a vitreous material is obtained. The material is pulverized, suspended in an aqueous solution or an alcohol solution, and dissolved in an aqueous solution, alcohol solution, acid, or the like to form a solution. The resulting solution is applied to a substrate, and hydration is initiated by reaction with water to produce a CaO—SiO₂—H₂O hydrate. The hydrate adheres to the application surface and the two are bonded together. The film has high adhesive strength because the hydrates adhere to each other.

Compositing with titanium dioxide is carried out in the manner described below. Titanium dioxide is admixed with the resulting solution, whereby the hydraulic material forms dots on the surface thereof. The solution is applied and hydration is initiated by reaction with water to produce a CaO—SiO₂—H₂O hydrate. The hydrate bonds with the titanium dioxide and simultaneously adheres to the application surface, and the two are bonded together. The film has high adhesive strength because the hydrates adhere to each other. Ammonium phosphate or another hardening agent may be added just prior to application to rapidly promote the hydration reaction, may be applied to the application surface in advance, or may be blown onto the target after application.

Octacalcium phosphate is preferably used as the calcium phosphate cement in the present invention. When calcium phosphate is used, octacalcium phosphate is most preferably precipitated on the surface of the titanium dioxide, and the precipitate may be hydrolyzed and converted to another crystal to form a bond. To apply the octacalcium phosphate, titanium dioxide is immersed is an aqueous solution containing phosphorus and calcium ions, and more particularly, in an aqueous solution containing calcium phosphate clusters.

Calcium phosphate contains one or more clusters of Ca₉(PO₄)₆ as a minimum unit. The configuration may be a collection of Ca₉(PO₄)₆ clusters alone, or may simultaneously contain OH, F, Cl, or the like. A portion of Ca may be Cr, Fe, or another metal, and a portion of P may be Ti, Al, or the like. These may crystalline or noncrystalline structures. In the case of a crystalline structure, apatite or tricalcium phosphate, octacalcium phosphate or another calcium phosphate crystal may be used. Apatite may be hydroxyapatite, apatite fluoride, or the like.

The size of the compound comprising one or more clusters of Ca₉(PO₄)₆ is preferably 0.01 to 50 microns, and is more preferably 0.1 nm to 10 microns. Preferably, 1 to 99% of the surface of the titanium dioxide is covered with a compound comprising one or more clusters of Ca₉(PO₄)₆.

The compound comprising one or more clusters of Ca₉(PO₄)₆ is preferable one produced from a solution containing at least phosphorus and calcium. In other words, Ca₉(PO₄)₆ in the form of clusters is produced by controlling the composition of the fluid, and the clusters are brought together to produce a compound. By suspending and immersing titanium dioxide powder in a solution, a compound comprising one or more clusters of Ca₉(PO₄)₆ is deposited on the surface thereof. The number of clusters may be one or more than one. When the number of clusters is more than one, a compound comprising one or more clusters of crystalline or noncrystalline Ca₉(PO₄)₆ is produced. The compound may be apatite, tricalcium phosphate, or the like, but fundamentally no limitation is imposed thereby. Ca₉(PO₄)₆ has excellent adhesive properties with substances, bacteria, viruses, aldehydes, ammonia, and other toxic substances.

If nothing is added to the solution, the clustered Ca₉(PO₄)₆ produced in the solution coalesces to form a compound. The fluid may be one that contains Na, K, Cl, Ca, P, Mg, Zn, or other ions, for example. A fluid with a pH of 7 to 8 is adequate, and a pH of 7.2 to 7.6 is preferred. Immersion should be carried out for 0.1 seconds to about 10 minutes.

The aspect in which the compound comprises one or more clusters of Ca₉(PO₄)₆ is not particularly limited, and a variety of aspects is possible. The compound comprising one or more clusters of Ca₉(PO₄)₆ may be produced in the form of layers, fine flakes, or fine grains. The resulting compound comprising one or more clusters of Ca₉(PO₄)₆ has a photocatalytic function. Photocatalytic activity is ordinarily generated by irradiation with light at a wavelength of 250 nm or less. Activation does not therefore occur with sunlight or fluorescent light available in a living space, so these do not ordinarily dissolve even when fiber, paper, resin, or other organic matter are mixed. The above-described compounds can adsorb large quantities of bacteria, viruses, aldehydes, ammonia, and other odorous components, as well as chemical substances that cause chemical hypersensitivity, so even if there is no contact with light, these toxic substances are adsorbed to obtain an environmental-cleaning and self-cleaning effect.

In the present invention, any method may be used for depositing hydraulic material on a substrate. Powder may be directly blown onto the substrate, and the powder is preferably dissolved in water or another solvent to carry out the application. A rigid film can be obtained as a result of the hydration reaction. The film hardening time is about two hours until the moisture evaporates, but a characteristic of hydration reactions is that the reaction continues thereafter and strength continues to increase.

The composite material of the present invention can be formed on the surface of a suitable structural member, and applying the composite material to exterior walls or to the exteriors of automobiles, vehicles, and the like can prevent the deposit of unwanted material due to oils and other substances in the atmosphere, and the target object can continue to be used without soiling on a permanent basis. In particular, this effect is entirely unobtainable without this invention at night, or in tunnels or in other locations where light is not present. A portion of the hydraulic material according to the present invention has a function for adsorbing bacteria, viruses, chemical substances, and other unwanted matter.

In the present invention, examples of the structural members on which the composite material may be formed include, for example, interior finishing materials for buildings comprising paper, fiber, resin, wood materials, ceramics, metal, and other materials used in wallpaper, construction materials, ceiling materials, flooring, sofas, tables, chairs, indoor sashes, indoor sliding partitions, doors, home appliance products, bookshelves and other furniture; tile, wood materials, metal, ceramics, resin, and other exterior finishing products; fibers, resins, paper, tile, and other ceramics, metal, and wood materials for the interior seating and flooring of private vehicles, taxis, buses, and other vehicles, as well as trains, airplanes, ships, and other modes of transportation; fiber, resin, paper, tile, and other ceramic, metal, wood, and other exterior finishing materials; and artificial plants and imitations flowers. These composite materials have an environmental-cleaning and self-cleaning effect.

Adhesive strength may be enhanced by mixing and applying, for example, organic binders, inorganic binders, or the like as a method for forming the composite material on the surface of structural members according to the present invention. The adhesive strength of the binder and the adhesive strength of the hydraulic material can be simultaneously obtained. As a result, environmental cleaning materials with excellent function and adhesiveness heretofore unavailable can be obtained. When mixed with an organic binder, titanium dioxide ordinarily changes color and becomes degraded because the binder itself dissolves, but these factors are not problematic even if an organic binder is used because the titanium dioxide and the binder do not make direct contact with the titanium dioxide coated with a hydraulic material.

Any known water-based or solvent-based organic paint or inorganic paint may be used as a paint component. Antifoaming agents, viscosity improvers, freezing stabilizers, moistening agents, pigments, water soluble resins, permeation auxiliaries, and other known additives may be added as required to the paint composition. Application of the paint composition to a paint target may be carried out with a brush, roller, air spray, airless spray, and other ordinary method. With the paint composition of the present invention, the resulting paint or coating film very rarely deteriorates or yellows due to oil or water deposits, and excellent durability and appearance can be maintained.

### BRIEF DESCRIPTION OF THE DRAWINGS

FIG. 1 shows all-wavelength absorption spectra produced by a spectrophotometer for the powder of example 1 and commercial apatite (UV-(a): powder of example 1, UV-(b): commercial apatite powder);

FIG. 2 shows XRD patterns of the hydraulic composite material ((a): AK-G, (b): AK-G (after hydration), (c): DI-G, and (d): DI-G (after hydration)); and

FIG. 3 shows a primary heat release peak immediately after injection and a secondary heat release peak about two hours later.

### BEST MODE FOR CARRYING OUT THE INVENTION

Next, the present invention is described in detail with examples, but the present invention is not limited thereby. Unless stated otherwise, the term “parts” as used herein refers to parts by weight.

(Hydration Test)

Water was added to the test powder, and the kneaded powder was loaded into a 3×4×5-mm metal mold and subjected to a hydration reaction while kept in a thermostat at 37° C. and 100% relative humidity. A sample was removed 20 hours after the start of the test, and the hardening condition thereof was observed. The sample was observed with a scanning electron microscope (hereinafter abbreviated as “SEM;” S-800 manufactured by Hitachi) before and after the hydration test, and the XRD, specific surface area, and the Fourier transform infrared absorption spectra (hereinafter abbreviated as “FT-IR”) were measured. The specific surface area was measured with the BET method (Monosorb manufactured by Quantachrome) produced by nitrogen adsorption. The exothermic curve of hydration was measured with a calorimeter. The measurement was made at 37° C. for 45 hours. Water (100 mL) was added to 2 g of test powder, the resulting product was agitated and let stand for 1 hour, and the filtrate was thereafter subjected to chemical analysis. ICP emission spectral analysis (hereinafter referred to as ICP) was used for the compositional analysis of the eluted ions. Water was added to the test powder, and the kneaded powder was loaded into a metal mold with a diameter of 6 mm and a height of 10 mm, directly subjected to a hydration reaction while kept in a thermostat at 37° C. and 100% relative humidity, removed after three hours and six hours, and then measured for compressive strength.

The solidification time was measured in accordance with the solidification test JIS T 6602 for dental zinc phosphate cement. First, normal consistency was determined as described below. Hardening fluid (0.5 mL) was placed on a kneading board and a suitable amount of test powder was added, yielding 0.5 mL of the kneaded product. Three minutes after the kneading was started, a 20-g glass plate was placed on the kneaded product and a dead weight (about 100 g) was carefully placed thereon. Ten minutes after the kneading was started, the dead weight and the glass plate were removed, and the dimensions of the largest and smallest portions were measured between parallel tangent lines on the spread-out sample. When the average dimension was 29 to 31 mm, this was taken as the normal consistency. Next, the solidification time was measured as described below. The test powder was kneaded to a normal consistency with a hardening fluid, and the resulting product was filled into a mold with an inside diameter 10 mm and a height of 5 mm and set in a thermostat at 37° C. and 100% relative humidity. The product was periodically removed, a 300-g Vicat needle was carefully lowered onto the surface of the test piece, and observation for the presence of a needle mark was made. The time calculated from the start of kneading was set as the solidification time when a needle mark had not been left. A hardening fluid consisting of water, physiological saline, and an aqueous solution of ammonium phosphate ((NH₄)2HPO₄.3.7 mol/L) was used.

### COMPARATIVE EXAMPLE 1

(Preparation and Effect of Apatite)

An aqueous solution (25 mg) of calcium chloride (10 mg/mL) was mixed with 10 cc of an aqueous solution composed of 8,000 mg of sodium chloride, 200 mg of potassium chloride, 1,150 mg of monobasic sodium phosphate, and 200 mg of dibasic potassium phosphate, and thereafter reacted with titanium dioxide (manufactured by Tayca) for 24 hours, thus yielding apatite. The resulting apatite was applied to glass in a thickness of about 10 microns, and left standing. The film did not harden at all, and peeled off when touched.

### Example 1

(Preparation and Effect of Octacalcium Phosphate)

An aqueous solution (25 mg) of calcium chloride (100 mg/mL) was mixed with 10 cc of an aqueous solution composed of 80,000 mg of sodium chloride, 2,000 mg of potassium chloride, 11,500 mg of monobasic sodium phosphate, and 2,000 mg of dibasic potassium phosphate, and thereafter reacted for five seconds. One liter of water was then immediately added to stop the reaction, thus yielding octacalcium phosphate. The resulting octacalcium phosphate was applied to glass to a thickness of about 10 microns, and left standing. A rigid film was formed after two hours. The calcium phosphate resulted in apatite crystals after the film dried. When this film was applied to interior wallpaper, formaldehyde (2.5 ppm) was reduced to 0.5 ppm after five hours, and when the solidification time was measured, solidification was completed in 90 minutes.

(Percentage of Organic Matter Removed)

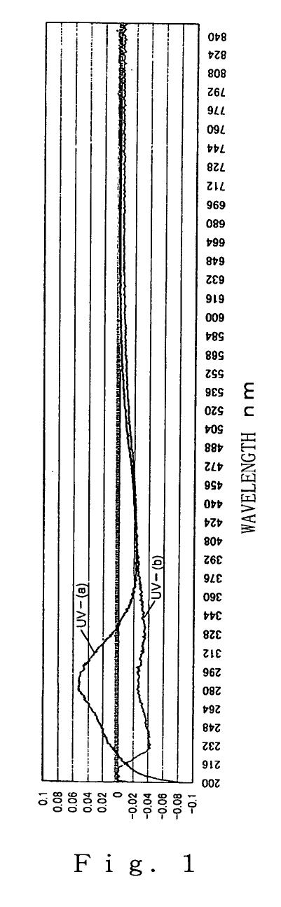

An aluminum substrate on which an inorganic paint film was formed was placed in a plastic container, a predetermined amount of formaldehyde, acetaldehyde, ammonia, and other substances was injected into the container, the substrate was irradiated with light from a 10-W black light for 30 minutes, and the percentage of acetaldehyde that was removed was calculated using gas chromatography. The all-wavelength absorption spectrum of the powder of the present example was measured with a spectrophotometer. As a result, the powder of the present example exhibited absorption light wavelengths of 250 nm or less, and it was apparent that light activation was present over this wide area (UV-(a) in FIG. 1). In contrast thereto, commercial apatite powder did not exhibit absorption at all (UV-(b) in FIG. 1).

### Example 2

Other than adding 1 mg of zinc nitrate (1 mg/mL) to an aqueous solution of calcium chloride, a film was formed in the same manner as in example 1. A rigid film was obtained in the same manner. The crystals generated at this point were also apatite, but it was apatite with photocatalytic activity that reacted to light with a wavelength of 300 nm or less. When the resulting apatite (5%) was added to acrylic resin and allowed to stand in room conditions, the resin did not exhibit discoloration or other variation. However, discoloration was observed when 300-nm light was irradiated for five hours. When this film was applied to interior wallpaper, ammonia (1.5 ppm) was reduced to 0.0 ppm after five hours.

### Example 3

Other than adding 1 mg of zinc nitrate (500 mg/mL) to an aqueous solution of calcium chloride, a film was formed in the same manner as in example 1. A rigid film was obtained in the same manner. The crystals generated at this point were also apatite, but it was apatite with photocatalytic activity that reacted to light with a wavelength of 350 nm or less. When the resulting apatite (5%) was added to acrylic resin and allowed to stand in room conditions, the resin did not exhibit discoloration or other variation. However, discoloration was observed when 350-nm light was irradiated for five hours. When this film was applied to interior wallpaper, floating bacterium (1 bacterium per liter) was reduced to zero bacteria per liter. When rice cake and bread were placed for one week inside a food container (made of polystyrene) to which the film was applied, mold did not grow at all. Rice with initially 2,000 E. coli bacteria had zero bacteria after one week. In a normal container, mold had grown after three days, and E. coli bacteria had increased to 100,000 or more.

### Example 4

(Preparation of Photocatalyst Partially Coated with Octacalcium Phosphate)

An aqueous solution (25 mg) of calcium chloride (100 mg/mL) was mixed with 2 g of anatase-type visible light titanium dioxide (manufactured by Tayca). The resulting product was mixed with 10 cc of an aqueous solution composed of 80,000 mg of sodium chloride, 2,000 mg of potassium chloride, 11,500 mg of monobasic sodium phosphate, and 2,000 mg of dibasic potassium phosphate, and thereafter reacted for five seconds. One liter of water was then immediately added to stop the reaction. A photocatalyst in which a portion (about 2% as observed with an electron microscope) of the surface of the titanium oxide particles was coated with octacalcium phosphate was obtained in this manner. When the film was applied to glass and exterior walls, an anti-soiling effect was exhibited, and when the film was applied to interior wallpaper, formaldehyde (2.5 ppm) was reduced to 0.5 ppm after two hours. This effect was maintained a month later, and semi-permanent use was possible. When the solidification time was measured, solidification was completed in 120 minutes. When the film was applied to the exterior walls of a building and to a car body, there was substantially no soiling on the application surface six months later with the film of the present example.

### Example 5

Other than adding 1 mg of zinc nitrate (1 mg/mL) to an aqueous solution of calcium chloride, a film was formed in the same manner as in example 2. A rigid film was obtained in the same manner. The crystals generated at this point were also apatite, but it was apatite with photocatalytic activity that reacted to light with a wavelength of 250 nm or less. When the resulting apatite (5%) was added to acrylic resin and allowed to stand in room conditions, the resin did not exhibit discoloration or other variation. However, discoloration was observed when 250-nm light was irradiated for five hours. When this film was applied to glass and exterior walls, an anti-soiling effect was exhibited, and when applied to interior wallpaper, ammonia (1.5 ppm) was reduced to 0.0 ppm after two hours. This effect was maintained a month later, and semi-permanent use was possible.

### Example 6

Other than adding 1 mg of zinc nitrate (500 mg/mL) to an aqueous solution of calcium chloride, a film was formed in the same manner as in example 2. A rigid film was obtained in the same manner. The crystals generated at this point were also apatite, but it was apatite with photocatalytic activity that reacted to light with a wavelength of 350 nm or less. When the resulting apatite (5%) was added to acrylic resin and allowed to stand in room conditions, the resin did not exhibit discoloration or other variation. However, discoloration was observed when 350-nm light was irradiated for five hours. When this film was applied to glass and exterior walls, an anti-soiling effect was exhibited, and when applied to interior wallpaper, floating bacterium (1 bacterium per liter) was reduced to zero bacteria per liter. When rice cake and bread were placed for one week inside a food container (made of polystyrene) to which the film was applied, mold did not grow at all. Rice with initially 2,000 E. coli bacteria had zero bacteria after one week. In a normal container, mold had grown after three days, and E. coli bacteria had increased to 100,000 or more. This effect was maintained a month later, and semi-permanent use was possible.

### Example 7

(Fabrication of a Calcium Silicate Solution)

Crystalline material and vitreous material were fabricated. Guaranteed reagents CaCO₃, MgO, and SiO₂ (manufactured by Junsei Chemical Co., Ltd.) were weighed so as to achieve a composition that comprised diopside (CaOMgO₂SiO₂) and akermanite (2CaO.MgO.2SiO₂), and the composition was mixed using a ball mill to produce a compound. The compound was used to fabricate a crystalline material by a solid-state reaction method. In other words, akermanite and diopside were baked for 30 minutes in an electric furnace at 1,400° C. and 1,350° C., respectively, and allowed to cool outside the furnace to fabricate the compound. The compound was placed in a crucible made of platinum, and the 2CaO.MgO.2SiO₂ composition and the CaO.MgO.2SiO₂ composition were melted for 30 minutes in an electric furnace at 1,500° C. and 1,400° C., respectively, and rapidly cooled in a stream of water to fabricate the vitreous material. The resulting test material was pulverized so as to allow complete passage through a 350-mesh screen.

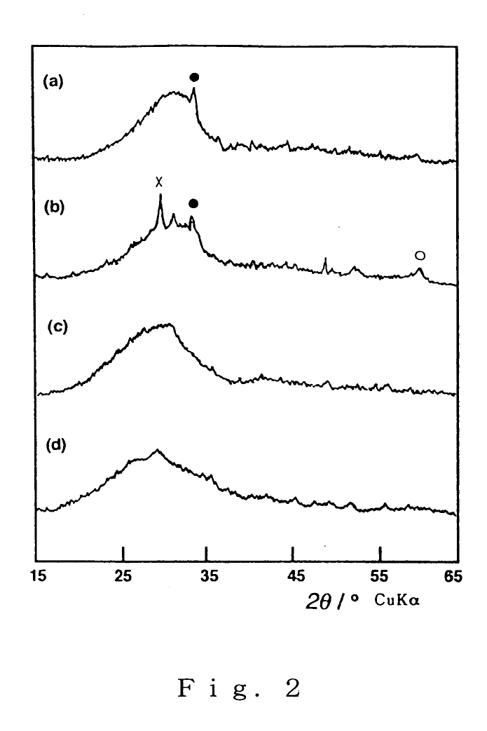

With the 2CaO.MgO.2SiO₂ composition, the material fabricated with the solid phase reaction method (hereinafter referred to as “AK”) resulted in the single akermanite phase. With the vitreous material (hereinafter referred to as “AK-G”), the product was believed to be substantially noncrystalline ((a) in FIG. 2). With the CaO.MgO.2SiO₂ composition, diopside alone was precipitated as the resulting material (hereinafter referred to as “DI”). With the vitreous material (hereinafter referred to as “DI-G”), the product was estimated to be noncrystalline ((c) in FIG. 2).

(Hydration Reactivity)

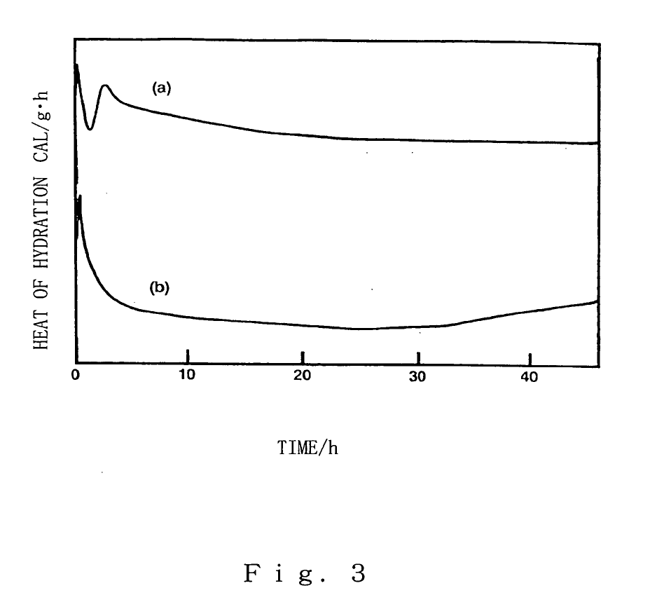

After the hydration test, the crystalline materials DI and AK fabricated with the solid-phase reaction method could not be removed from the mold without causing damage, and it was apparent that the materials had not hardened. Newly formed product material was not found either before or after the hydration test, and the particles had simply solidified. The specific surface area of both materials after the hydration test had increased five times in relation to the area observed prior to the test. Newly formed product material was precipitated by the hydration test, and the specific surface area had increased. As for the AK-G, the material after the hydration test could be removed from the mold while retaining its original form, and it was apparent that the material had hardened ((b) in FIG. 2). The material was subjected to ultrasonic dispersion treatment for 30 minutes in water, but no damage was observed and there was no clouding. Hydration was more advanced in comparison with DI and AK. A primary heat release peak immediately after injection and a secondary heat release peak about two hours later, which are thought to be due to hydration reaction, were observed (FIG. 3, (a): AK-G heat release, (b): DI-G heat release).

It is apparent from the XRD pattern that CaO—SiO₂—H₂O (hereinafter referred to as “C—S—H”) was generated in the form of a thin plate after the hydration test in the case of AK-G ((b) in FIG. 2). In an SEM photograph, a large quantity of product material was precipitated in the form of small thin plates on the surface of the particles. The precipitants in the form of thin plates are thought to be C—S—H, considering the characteristic shape and the results of XRD. The specific surface area value after the hydration test was at least 20 times the area existing prior to the test. The reason that the specific surface area value had increased was thought to be the C—S—H generated by the hydration reaction.

Hardening due to the hydration reaction was observed even with DI-G. However, it was assumed the hydraulic properties were weak in comparison with AK-G. The test material after the hydration test could be removed from the mold while retaining its original form. When the material was subjected to ultrasonic dispersion treatment for 30 minutes in water, damage to the test material was not observed, but the water was clouded. The reason for the clouded water was thought to be the inadequate hardening. The amounts of eluted Ca and Mg ions analyzed by ICP were 0.24 and 0.07 mg/g, respectively. A single primary heat release peak was observed in the exothermic curve of hydration immediately after injection ((b) in FIG. 3). However, a gradual heat release began 30 minutes later, and it is can be predicted that a secondary heat release peak would be present 45 hours or later, which is beyond the measurement range.

It is apparent from the XRD pattern that with DI-G (after the hydration test), a C—S—H film was formed on the surface of the particles ((d) in FIG. 2). In the XRD pattern, the halo observed prior to the hydration test at an angle of about 30° (2θ) had weakened after the hydration test. In an SEM photograph, evidence that the particle surface had dissolved was observed. Based on the above results, it is surmised that C—S—H film was being generated on the surface of the particles. This is thought to be the state that exists prior to the growth of C—S—H into crystals shaped as plates. For this reason, it can be said that the C—S—H was clearly not detected in the XRD. The specific surface area value was at least 20 times greater due to the hydration test. This is thought to be due the fact that the generated C—S—H had low crystallinity, so the surface area was large.

(Compressive Strength)

With the AK-G, a compressive strength of 10 MPa was obtained in three hours of hydration testing, and 27 MPa in six hours. With DI-G, the strength was low and measurement was not possible.

(Solidification Time)

When the solidification times of the hardening fluids were measured, AK, DI, and DI-G solidified in three hours when the hardening fluid was water and physiological saline, but AK-G solidified after 90 minutes. When ammonium phosphate was used, the crystalline materials DI and AK solidified in six minutes and four minutes, respectively. The vitreous materials DI-G and AK-G set instantaneously. Each of the test materials exhibited a marked solidification reaction by using ammonium phosphate as the hardening fluid.

### Example 8

The powder obtained in example 7 was mixed with titanium dioxide powder (manufactured by Tayca, 20 nm) and kneaded with water. The resulting product was applied and one hour was allowed to pass. As a result, a composite film consisting of rigid titanium oxide and silicate were obtained. The solidification time and hydration reaction were the same as in example 7. Odor components were adequately adsorbed and dissolved by the photocatalyst. As a result, it was possible to treat 3.0 ppm of ammonia in one hour. The present invention may be implemented with a variety of other aspects without departing from the spirit and principal characteristics thereof. For this reason, the above-described examples are no more than examples regarding all points of the invention, and must not be interpreted in a limiting fashion. Furthermore, modifications in the equivalent range of the claims are regarded to be within the scope of the present invention.

### INDUSTRIAL APPLICABILITY

As described above, the present invention relates to a hydraulic composite material having photocatalytic activity and to a method of production thereof. Following are some of the positive effects of the present invention: 1) a hydraulic composite material is provided having a substance-adsorbing function, a humidity-adjusting function, photocatalytic function, and/or other composite functions; 2) it is possible to obtain a composite material that has self-hardening and self-adhesive characteristics, and that solidifies, becomes fixed, and adheres by simple application without the use of a binder; 3) a novel material in which a calcium silicate cement or a calcium phosphate cement is used can be provided; and 4) a structural member with a hydraulic composite material formed on the surface thereof can be provided.

1. A hydraulic composite material having a substance-adsorbing function, humidity-adjusting function, and/or photocatalytic function, characterized in that calcium silicate cement or calcium phosphate cement is deposited as a hydraulic material on a suitable substrate in the presence of water so as to be hardened and to thereby cause the cement to solidify, be fixed, and self-adhere to the application surface.

2. The composite material according to claim 1, wherein the substrate is a humidity-adjusting material or a photocatalyst.

3. The composite material according to claim 1, wherein the hydraulic material is applied to the surface of the photocatalytic particles and the photocatalytic particles are bonded by a hydration reaction via the hydraulic material.

4. The composite material according to claim 1, wherein calcium silicate cement as the hydraulic material has as its main component calcium silicate, calcium aluminate silicate, or calcium magnesium silicate.

5. The composite material according to claim 4, wherein the calcium silicate is alite or belite, the calcium aluminate silicate is anorthite, and the calcium magnesium silicate is diopside.

6. The composite material according to claim 1, wherein calcium phosphate cement as the hydraulic material is octacalcium phosphate.

7. A method of producing hydraulic composite material, characterized in that a suspension or solution containing the above hydraulic material is mixed with a photocatalyst.

8. A method of producing hydraulic composite material, characterized by immersing a photocatalyst in a solution containing phosphorus and calcium, and depositing the hydraulic calcium phosphate on the surface thereof.

9. The method of producing hydraulic composite material according to claim 8, wherein octacalcium phosphate is deposited on the surface by hydrolyzing octacalcium phosphate.

10. The method of producing hydraulic composite material according to claim 8, wherein the calcium phosphate has photocatalytic properties.

11. The method of producing hydraulic composite material according to claim 10, wherein the photocatalytic activity of the calcium phosphate is brought about by light with a wavelength of 250 nm or less, does not occur with sunlight, fluorescent light, or another normal light source, and is initiated solely when irradiated with low-wavelength UV.

12. A structural member characterized in that the hydraulic composite material according to any one of claims 1 to 5 is formed on the surface of a structural member, and a substance-adsorbing function, humidity-adjusting function, and/or photocatalytic function is imparted thereto.
